(19) United States
(12) Patent Application Publication
(10) Pub. No.: US 2019/0155548 A1
(43) Pub. Date: May 23, 2019

(54) COMPUTER SYSTEM AND STORAGE ACCESS APPARATUS

(71) Applicant: HUAWEI TECHNOLOGIES CO., LTD., SHENZHEN (CN)

(72) Inventors: Xiaolin JIA, Hangzhou (CN); Muhui LIN, Shenzhen (CN)

(21) Appl. No.: 16/258,575

(22) Filed: Jan. 26, 2019

Related U.S. Application Data
(63) Continuation of application No. PCT/CN2017/092816, filed on Jul. 13, 2017.

(30) Foreign Application Priority Data
Sep. 30, 2016 (CN) 201610878406.9

(51) Int. Cl. G06F 3/06; G06F 9/455; G06F 9/50; G06F 12/08

(52) U.S. Cl. CPC G06F 3/0665; G06F 9/45558; G06F 9/5005; G06F 2009/45595; G06F 3/0611; G06F 3/067; G06F 2009/45579; G06F 12/08

(57) ABSTRACT

A computer system and a storage access apparatus are provided. The storage access apparatus is configured to: configure at least one virtual function VF by using a physical function PF of an single-root I/O virtualization (SR-IOV) function, and configure a VM-VF association relationship, so that a direct access path is established between a VM and a VF that are associated; and obtain, by using a network interface, data block resources provided by at least one network storage device that is connected to the storage access apparatus, form a plurality of virtual volumes by using the obtained data block resources, and configure a VF-virtual volume association relationship. Therefore, by using a storage access method supported by the storage access apparatus, a storage access path and latency can be shortened, and occupation of CPU resources in a compute node can be reduced.

### CROSS-REFERENCE TO RELATED APPLICATIONS

This application is a continuation of International Application No. PCT/CN2017/092816, filed on Jul. 13, 2017, which claims priority to Chinese Patent Application No. 201610878406.9, filed on Sep. 30, 2016. The disclosures of the aforementioned applications are hereby incorporated by reference in their entireties.

### TECHNICAL FIELD

The present application relates to storage technologies, and in particular, to a computer system and a storage access apparatus.

### BACKGROUND

Virtualization technologies are applied to an increasingly wide scope, and a demand for improving resource utilization through network and storage virtualization and improving performance of network and storage access by a virtual machine is increasingly strong.

In an existing virtualization technology, virtual storage resource management is implemented using a virtualization layer (such as Hypervisor) or a virtual machine manager (VMM). The virtualization layer or the virtual machine manager encapsulates attached storage resources into virtual hard disks, and allocates the virtual hard disks to different VMs for use. A path by which a virtual machine (VM) accesses an allocated storage resource is relatively complex. The virtual machine needs to be connected to a back-end access interface (the back-end access interface is usually in kennel mode) at the virtualization layer or the virtual machine manager by using a front-end access interface deployed on the virtual machine, then a storage access request is forwarded by the back-end access interface to a storage resource scheduling module deployed at the virtualization layer or the virtual machine manager for physical storage resource scheduling or positioning (the storage resource scheduling module is usually in user mode), and finally the storage access request can be forwarded to a physical storage resource.

In the foregoing storage resource access manner, the access path is complex and long, and a latency is large; and the access request has to pass the front-end access interface of the virtual machine, and the back-end access interface and the storage resource scheduling module of the virtualization layer or the virtual machine manager. These all need to occupy CPU resources of a host, affecting CPU resource occupation of the host.

### SUMMARY

Embodiments of the present application provide a computer system and a storage access apparatus, so as to implement direct access of a virtual machine to a storage resource, shorten a storage access path and latency, and reduce occupation of CPU resources in a compute node.

According to a first aspect, an embodiment of the present application provides a computer system, and the computer system includes n compute nodes, n storage access apparatuses, and m network storage devices, where at least one virtual machine VM runs on each of the compute nodes. The m network storage devices provide distributed storage resources for the at least one virtual machine. Each compute node includes a processor, a memory, and a storage access apparatus, and n and m are integers greater than or equal to 1.

Each storage access apparatus includes a hardware-form processing unit, a Peripheral Component Interconnect Express (PCIe) bus interface, and a network interface, one end of the storage access apparatus is connected to a processor of the at least one compute node by using the PCIe interface, and another end of the storage access apparatus is coupled to the at least one network storage device by using the network interface.

The storage access apparatus in this application supports single-root I/O virtualization SR-IOV and is configured to: configure at least one virtual function (VF) using a physical function (PF) of the SR-IOV function, and configure a VM-VF association relationship, so that a direct access path is established between a VM and a VF that are associated, where one VM corresponds to one VF; and the storage access apparatus further supports a distributed storage resource scheduling function and is configured to: obtain, using the network interface, data block resources provided by the at least one network storage device that is coupled to the storage access apparatus, form a plurality of virtual volumes using the obtained data block resources, and configure a VF-virtual volume association relationship, where one VF corresponds to at least one virtual volume.

The storage access apparatus provided in this application can directly establish a direct access path between a storage resource and a virtual machine. Therefore, a storage access method supported by the storage access apparatus does not require front-end and back-end software stacks that are used by a VM to access a storage resource in an existing cloud computing virtualization technology, so that a software stack path and a latency are shortened and performance is enhanced. In addition, the method does not require a large quantity of host (a CPU in a compute node) resources, so that host resource utilization is improved.

In one embodiment, a PF back-end driver is deployed in the storage access apparatus provided in this application, and a PF front-end driver is deployed in the compute node coupled to the storage access apparatus; after being started, the storage access apparatus loads the PF back-end driver to perform initialization; and the compute node connected to the storage access apparatus loads the PF front-end driver, obtains resource information of the storage access apparatus by using the PF front-end driver, and delivers a configuration command to the storage access apparatus based on the resource information of the storage access apparatus, so that the storage access apparatus performs resource configuration, to allocate corresponding hardware resources to the PF and each VF.

In one embodiment, the storage access apparatus provided in this application specifically executes a VM-VF association operation as follows: after receiving a first VM association command sent by an upper-layer application, the compute node connected to the storage access apparatus forwards the first VM association command to the PF back-end driver module using the PF front-end driver module; and after receiving the first VM association command by using the PF back-end driver module, the storage access apparatus configures a corresponding first VF for a first VM designated in the first VM association command, and records an association relationship between the first VM and the first VF.

In one embodiment, the storage access apparatus provided in this application executes a VF-virtual volume association operation as follows: the storage access apparatus (the storage access apparatus may provide a management interface, such as an interface that provides a command-line interface (CLI) or a web user interface (UI) for a management layer) receives an allocation request for allocating a storage resource to the first VM, determines the first VF associated with the first VM, allocates at least one of the plurality of virtual volumes to the first VM, creates an association relationship between the allocated at least one virtual volume and the first VF, and returns an allocation response, where the allocation response includes information about the at least one virtual volume that is allocated to the first VM.

In one embodiment, the storage access apparatus provided in this application executes a VM read or write request as follows: the first VF of the storage access apparatus receives an I/O request of the first VM using the direct access path, places the I/O request into an I/O queue of the first VF, determines, based on the virtual volume associated with the first VF, a data block that is in the network storage device and that corresponds to the I/O request, and executes a read or write operation on the data block that is in the network storage device and that corresponds to the I/O request.

According to a second aspect, this application further provides a storage access apparatus. The storage access apparatus includes a hardware-form processing unit, a PCIe bus interface, and a network interface, one end of the storage access apparatus is connected to a processor of a compute node using the PCIe interface, and another end of the storage access apparatus is connected to at least one network storage device by using the network interface.

At least one VM runs on the compute node, and the at least one network storage device provides distributed storage resources for the at least one virtual machine.

The storage access apparatus provided in this application includes a direct access module, where the direct access module supports single-root I/O virtualization (SR-IOV) and is configured to: perform virtualization to obtain at least one virtual function VF using a PF of the SR-IOV function, and configure a VM-VF association relationship, so that a direct access path is established between a VM and a VF that are associated, where one VM corresponds to one VF; and the storage access apparatus further includes a resource scheduler, where the resource scheduler supports a distributed storage resource scheduling function and is configured to: obtain, using the network interface, data block resources provided by the at least one network storage device that is coupled to the storage access apparatus, form a plurality of virtual volumes using the obtained data block resources, and configure a VF-virtual volume association relationship, where one VF corresponds to at least one virtual volume.

According to a third aspect, this application further provides a storage access apparatus, and the storage access apparatus includes a hardware-form processing unit, a first interface (such as a PCIe bus interface), and a second interface (such as a network interface).

The hardware-form processing unit in the storage access apparatus provided in this application is configured to: support an SR-IOV function and a distributed storage resource scheduling function; perform virtualization to obtain at least one VF using a PF of the SR-IOV function, and configure a VM-VF association relationship, so that a direct access path is established between a VM and a VF that are associated, where one VM corresponds to one VF; and obtain, using the network interface, data block resources provided by the at least one network storage device that is connected to the storage access apparatus, form a plurality of virtual volumes using the obtained data block resources, and configure a VF-virtual volume association relationship, where one VF corresponds to at least one virtual volume. The hardware-form processing unit in the storage access apparatus provided in this application is configured to perform the following specific storage access method in this application: After a first VM sends an I/O request, a first VF of the storage access apparatus receives the I/O request of the first VM using the direct access path, and places the I/O request into an I/O queue of the first VF; and the processing unit then determines, based on a virtual volume associated with the first VF, a data block that is in the network storage device and that corresponds to the I/O request, and executes a read or write operation on the data block that is in the network storage device and that corresponds to the I/O request.

In this application, the storage access method implemented by the storage access apparatus no longer requires passing a front-end interface and a back-end interface that are at a virtualization medium layer, so that a VM access path, a software stack path, and an access latency are shortened, and storage access performance is enhanced. In addition, the method does not require a large quantity of host (a CPU in a compute node) resources, so that host resource utilization is improved.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may derive other drawings from these accompanying drawings without creative efforts.

FIG. 1 is a schematic architectural diagram of a computer system according to this application;

FIG. 2 is a schematic diagram of composition details of a computer system according to this application; and

FIG. 3 is a schematic structural diagram of a storage access apparatus according to this application.

### DESCRIPTION OF EMBODIMENTS

The following clearly describes the technical solutions in the embodiments of the present application with reference to the accompanying drawings in the embodiments of the present application. Apparently, the described embodiments are some rather than all of the embodiments of the present application. All other embodiments obtained by a person of ordinary skill in the art based on the embodiments of the present application without creative efforts shall fall within the protection scope of the present application.

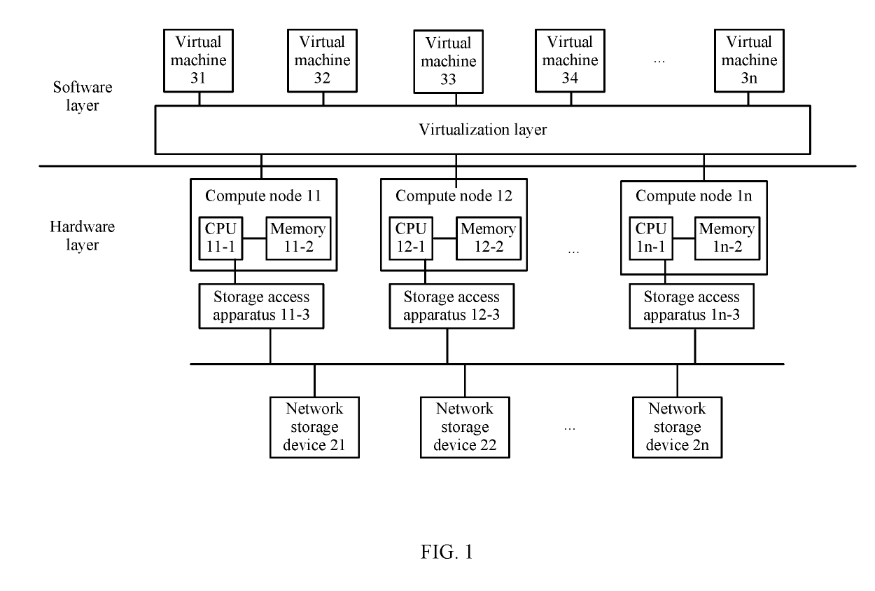

Referring to FIG. 1, FIG. 1 is a schematic diagram of a computer system configured to perform a storage access method in this application. FIG. 1 shows a hardware layer and a software layer of the computer system. The hardware layer of the computer system includes n compute nodes (in actual operation, n may be any positive integer greater than or equal to 1), n storage access apparatuses, and m network storage devices (in actual operation, m may be any positive integer greater than or equal to 1). Each compute node may be a blade server, a rack server, or another type of server, and is configured to provide computing resources. Each network storage device may be a storage area network (SAN) storage device, includes a storage array, an HDD hard disk, an SDD hard disk, or the like, and is configured to provide storage resources. The software layer of the computer system includes a virtualization layer (which may be distributed in operating systems (Oss) of the compute nodes, or may be independently set in an operating system of one of the compute nodes) configured to perform virtualization, and a plurality of virtual machines (VMs).

The following describes a composition of a compute node using a compute node 11 in FIG. 1 as an example. The compute node 11 includes a CPU 11-1 and a memory 11-2, and may further include some other hardware components, such as a network interface card (which is not shown in the figure) and the network interface card has at least one network interface. The CPU 11-1 may be one or more Intel processor chips, and the memory 11-2 provides a storage capacity for the CPU 11-1, temporarily stores a program and data that are executed by the CPU 11-1, and may be a random access memory (RAM), a read-only memory (ROM), a cache (CACHE), or the like.

A storage access apparatus 11-3 is a hardware device newly provided in this application and plays a key role in implementing the storage access method in this application. The storage access apparatus 11-3 includes a hardware-form processing unit, a PCIe bus interface, and a network interface, one end of the storage access apparatus 11-3 is connected to the CPU 11-1 using the PCIe (the storage access apparatus 11-3 may be considered as one PCIe endpoint device connected to the CPU 11-1 of the compute node), and another end of the storage access apparatus 11-3 is connected to the network storage devices (such as the network storage devices 21, 22, . . . , and 2n) using the network interface (ETH, ROCE, IB, or the like). A hardware-form processing unit is included inside the storage access apparatus 11-3, and the processing chip inside the storage access apparatus 11-3 may be implemented by using a system on chip (SOC) , an application specific integrated circuit Application Specific Integrated Circuit (ASIC), or the like, or may be implemented by using a CPU. Firmware, an OS guide medium, and another hardware device such as a power source or a clock may be further included inside the storage access apparatus 11-3. The storage access apparatus 11-3 supports a storage-based single-root I/O virtualization (SR-IOV) function, and the processing chip inside the storage access apparatus 11-3 provides a PCIe endpoint device interface that supports SR-IOV. The storage access apparatus 11-3 that supports an SR-IOV technology includes a physical function (PF) and a virtual function (VF). The PF is a PCIe function that supports an SR-IOV extension function and is used to configure and manage an SR-IOV function characteristic, and the PF is an all-purpose PCIe function and may be discovered, managed, and processed like any other PCIe device. The PF owns all resources configured, and may be used to configure or control the storage access apparatus 11-3. The VF is a function associated with a physical function, and the VF is a lightweight PCIe function and may share one or more physical resources with the physical function and another VF that is associated with the same physical function as the VF. Each SR-IOV device may have at least one PF, and for each PF, one or more VFs associated with the PF may be configured. The PF may create a VF by using a register, and the VF is presented in PCIe configuration space. Each VF has its own PCIe configuration space. The VF may be externally displayed as a physically existing PCIe device, and one or more virtual functions may be allocated to a virtual machine by simulating configuration space. The storage access apparatus 11-3 supports SR-IOV and is configured to: configure at least one virtual function VF by using a physical function PF of the SR-IOV function, and configure a VM-VF association relationship, so that a direct access path is established between a VM and a VF that are associated. One VM corresponds to one VF.

The storage access apparatus 11-3 further supports a distributed storage resource scheduling function and is configured to: obtain, by using the network interface, data block resources provided by the at least one network storage device that is connected to the storage access apparatus, form a plurality of virtual volumes using the obtained data block resources, and configure a VF-virtual volume association relationship, where one VF corresponds to at least one virtual volume. In brief, storage resources in the network storage devices are encapsulated into virtual volumes, and the virtual volumes are directly accessed by the VM by using the VF.

The virtual volume in this application may also be referred to as a virtual disk. Compared with a physical disk, the virtual disk is mainly a storage resource provided for use by a virtual machine and is usually obtained by integrating physical storage resources.

The storage access apparatus 11-3 provided in this application can directly establish a direct access path between a storage resource and a VM. Therefore, the storage access method supported by the storage access apparatus 11-3 does not require front-end and back-end software stacks that are used by a VM to access a storage resource in an existing cloud computing virtualization technology, so that a software stack path and a latency are shortened and performance is enhanced. In addition, the method does not require a large quantity of host (a CPU in a compute node) resources, so that host resource utilization is improved.

Devices 21 to 2n are network storage devices, and the storage access apparatus 11-3 is connected to the devices 21 to 2n using the network interface. The network storage devices 21 to 2n may form a distributed storage resource pool, and a capacity of the storage resource pool can be randomly expanded. Each network storage device includes a storage controller and a storage medium, to implement hard disk management and bottom-layer data management, and present a data block and a data block call interface for the storage access apparatus. Each network storage device may be remotely deployed rather than deployed on a local compute node. The network storage devices 21 to 2n support distributed storage manners including a multi-copy manner, an erasure code (EC), or the like, and can ensure liability of storage resources.

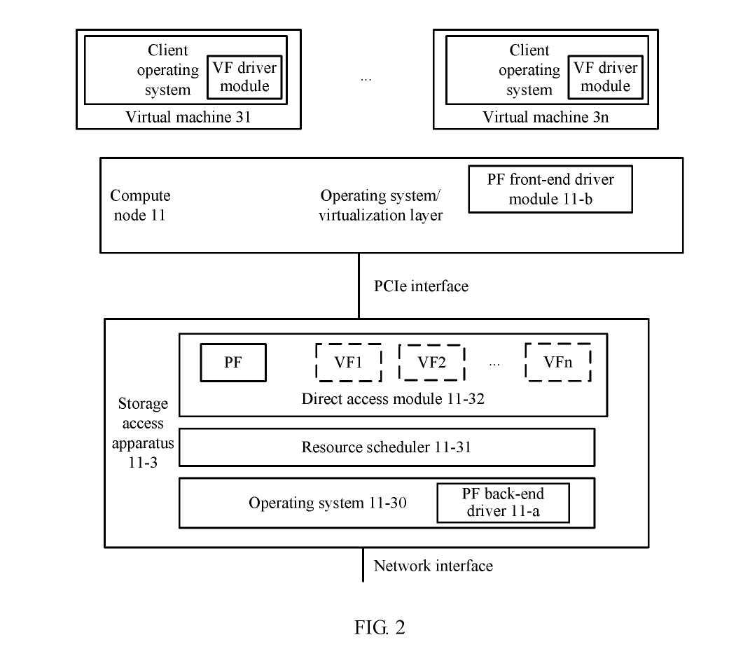

FIG. 2 is a schematic diagram of a software module composition of a computer system according to this application. In FIG. 2, only one storage access apparatus is shown as an example. The storage access apparatus 11-3 includes an operating system 11-30, a resource scheduler 11-31, and a direct access module 11-32. A PF back-end driver 11-a is loaded in the operating system 11-30, and the direct access module 11-32 includes a PF and a plurality of VFs. A PF front-end driver 11-b is configured in an operating system of a compute node 11. A VF driver module is loaded in a client operating system of a virtual machine 31.

The direct access module 11-32 of the storage access apparatus 11-3 supports SR-IOV and is configured to: configure at least one virtual function VF by using a physical function PF of the SR-IOV function, and configure a VM-VF association relationship, so that a direct access path is established between a VM and a VF that are associated.

In one embodiment, after being started, the storage access apparatus 11-3 loads the PF back-end driver 11-a to initialize the SR-IOV function; and the compute node 11 loads the PF front-end driver 11-b, and uses the PF front-end driver 11-b to obtain resource information of the storage access apparatus, configure a queue or interrupt resource for the storage access apparatus, and communicate with the storage access apparatus 11-3.

The resource scheduler 11-31 of the storage access apparatus 11-3 further supports a distributed storage resource scheduling function and is configured to: obtain, by using a network interface, data block resources provided by at least one network storage device that is connected to the storage access apparatus 11-3, form a plurality of virtual volumes by using the obtained data block resources, configure a virtual volume corresponding to a VF, and record an association relationship between the VF and the corresponding virtual volume.

In one embodiment, the resource scheduler 11-31 encapsulates the data block resources into the virtual volumes by accessing and calling data blocks of the network storage device and metadata of the data blocks, and configures a VF and a virtual volume to form a mapping relationship between the VF and the virtual volume. In addition, the resource scheduler 11-31 is further responsible for managing metadata of the virtual volumes, and is capable of finding specific physical addresses of data blocks of the network storage device based on a determined virtual volume.

A management agent unit (not shown in FIG. 2) may further be deployed on the storage access apparatus 11-3. The management agent unit provides a management interface and is connected to a management layer of the computer system (the management layer of the computer system may be a cloud management component, a storage management component, or another component that is configured to manage the computer system). The management layer of the computer system may determine, based on a command of an upper-layer application or based on a pre-configured management policy, to perform virtual machine resource allocation. When determining that virtual machine resource allocation needs to be performed, the management layer of the computer system may initiate, by using the management interface, an allocation request for allocating a storage resource to a VM. In one embodiment, the allocation request for allocating a storage resource to a VM may be a request for creating a volume or attaching a volume. A random virtual machine is used as an example, and in this application, a first virtual machine is used to represent the random virtual machine. The storage access apparatus 11-3 receives, using the management interface, an allocation request for allocating a storage resource to the first VM, determines a first VF associated with the first VM, allocates at least one of the plurality of virtual volumes to the first VM, creates an association relationship between the allocated at least one virtual volume and the first VF, and returns an allocation response. The allocation response includes information about the at least one virtual volume that is allocated to the first VM.

After the direct access module 11-32 and the resource scheduler 11-31 of the storage access apparatus implement VM-VF association and VF-virtual volume association respectively, direct access between the VM and the virtual volume is implemented in effect. After the first VM sends an I/O request, the first VF of the storage access apparatus 11-3 receives the I/O request of the first VM using a direct access path, and places the I/O request into an I/O queue of the first VF. The resource scheduler of the storage access apparatus 11-3 then determines, based on the virtual volume associated with the first VF, a data block that is in the network storage device and that corresponds to the I/O request, and executes a read or write operation on the data block that is in the network storage device and that corresponds to the I/O request.

The storage access method in this application does not require passing a front-end interface and a back-end interface that are at a virtualization medium layer, so that a VM access path, a software stack path, and an access latency are shortened, and storage access performance is enhanced. In addition, the method does not require a large quantity of host (a CPU in a compute node) resources, so that host resource utilization is improved.

A VF driver is deployed in each VM. The VF driver may be a small computer system interface (SCSI) driver or an non-volatile memory express (NVMe) driver and is deployed inside the VM. After the VM sends an I/O request, the I/O request is directly sent, using the VF driver, to a VF associated with the VM, and after the storage access apparatus completes an operation of the I/O request, an operation result of the I/O request is returned, also by using the VF driver, to the VM that sends the I/O request.

The following specifically describes, with reference to FIG. 2, procedures of operations executed by the storage access apparatus.

1. A procedure of initialization configuration of the storage access apparatus and the compute node to implement communication is as follows: After the storage access apparatus 11-3 is started, the storage access apparatus 11-3 loads the PF back-end driver 11-a, and the storage access apparatus 11-3 executes initialization. The initialization process may include PF register initialization and VF register initialization, configuration of in-band/out-of-band address translation unit mapping, doorbell (doorbell) address configuration, direct memory access (DMA) initialization, and base address register (BAR) initialization. An objective of the initialization is to ensure that the storage access apparatus 11-3 can be enumerated and recognized by the compute node 11 as a PCIe endpoint device of the compute node 11, so as to implement interrupt transmission and memory access with hardware of the compute node 11. The compute node 11 loads the PF front-end driver 11-b, obtains the resource information on the storage access apparatus 11-3, and configures, for example, interrupt, queue, and base address register resources for the PF or the VFs in the storage access apparatus 11-3, to implement communication with the storage access apparatus.

In this application, the PF in the storage access apparatus 11-3 may be used to implement functions such as enabling SR-IOV, querying or allocating a storage medium that is in a storage device, and maintaining a resource allocation table. In one embodiment, the compute node 11 may load the PF front-end driver 11-b, enable the SR-IOV function, create a management queue, and deliver, using the management queue of the PF front-end driver, a resource query command to the PF. After receiving the query command, the PF may return statuses of the storage medium, the interrupt resource, and the queue resource included in the storage device to the compute node 11. After receiving the statuses, of the storage medium, the interrupt resource, and the queue resource, returned by the PF, the compute node 11 may send an allocation command to the PF. The PF divides an integral storage resource into a plurality of storage sub-resources based on the allocation command, so as to allocate the storage sub-resources, the queue resource, and the interrupt resource to the PF or the VFs.

2. A procedure of configuring the VM-VF association relationship is as follows: A VM and a VF may be associated when the VM is being newly created or may be associated after the VM is created. A management module or an upper-layer application of the VM sends a VM association command to the PF back-end driver 11-a of the storage access apparatus 11-3 by using the PF front-end driver 11-b on the compute node 11. The direct access module 11-32 of the storage access apparatus 11-3 selects an associated VF, and associates the VF and the VM, that is, creating a mapping relationship between the VF and the VM, records an association relationship between the designated VM and the corresponding VF, and returns an association success message to the PF front-end driver 11-b. The PF front-end driver 11-b then returns the association success message to the management module or the upper-layer application module of the VM.

3. A procedure of integrating data blocks in the network storage device into virtual volumes is as follows: There is no specific timing relationship between this procedure and procedure 2. After the storage access apparatus 11-3 is started, these two procedures may be executed at any time. The resource scheduler 11-31 obtains, by using the network interface, storage resources from distributed network storage devices, that is, data block resources of the network storage devices, forms a plurality of virtual volumes by using the obtained data block resources, and records a correspondence between the virtual volumes and physical addresses of the data blocks (management of metadata of the virtual volumes).

4. A procedure of configuring the VF-virtual volume association relationship is as follows: Association implemented during volume attachment is used as an example (or association may be implemented during volume creation). A user or an upper-layer application initiates a command for attaching a volume to the first VM. The storage access apparatus receives the volume attachment command by using the management interface, and determines the first VF associated with the VM. The resource schedule 11-31 selects, for the first VM, at least one virtual volume from the plurality of virtual volumes formed in procedure 3, creates an association relationship between the selected at least one virtual volume and the first VF, and returns a volume attachment response. The volume attachment response includes information about the at least one virtual volume that is allocated to the first VM.

5. A procedure of processing an I/O request of a VM is as follows: The first VM initiates the I/O request. The first VF is further used to receive the I/O request of the first VM by using the direct access path, and place the I/O request into the I/O queue of the first VF. The resource scheduler 11-31 determines, based on the virtual volume associated with the first VF, the data block that is in the network storage device and that corresponds to the I/O request, and executes the read or write operation on the data block that is in the network storage device and that corresponds to the I/O request. After completing the operation of the I/O request, the resource scheduler 11-31 returns, by using the VF driver, the operation result of the I/O request to the first VM that sends the I/O request.

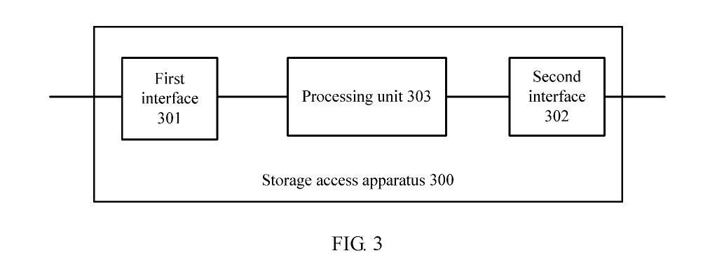

As shown in FIG. 3, an embodiment of the present application further provides a storage access apparatus 300. The storage access apparatus 300 includes a first interface 301, a second interface 302, and a processing unit 303. Specifically, the first interface 301 is a PCIe interface and is configured to connect a CPU of a compute node, the second interface is a network interface and is configured to connect a network storage device, and the processing unit 303 may be implemented by a hardware-form processing circuit, such as a system on chip SOC, an application specific integrated circuit ASIC, or a field programmable gate array (FPGA), or the processing unit 303 may be implemented in a form of a combination of a CPU and a memory (including corresponding code).

The storage access apparatus shown in FIG. 3 is configured to implement the functions of the storage access apparatus 11-3 described in FIG. 1 and FIG. 2. Details are not repeatedly described herein.

A person of ordinary skill in the art may be aware that the units and algorithm steps in the examples described with reference to the embodiments disclosed in this specification can be implemented by electronic hardware, computer software, or a combination thereof. To clearly describe the interchangeability between hardware and software, the foregoing has generally described compositions and steps in each example based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not be performed. In addition, the displayed or discussed mutual couplings or direct couplings or communication connections may be indirect couplings or communication connections through some interfaces, apparatuses, or units, and may be electrical, mechanical or other forms of connections.

The units described as separate parts may or may not be physically separate. Parts displayed as units may or may not be physical units, and may be located in one position or distributed on a plurality of network units. Some or all of the units may be selected depending on actual requirements to achieve the objectives of the solutions of the embodiments of the present application.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific embodiments of the present application, but are not intended to limit the protection scope of the present application. Any modification or replacement readily figured out by a person skilled in the art within the technical scope disclosed in the present application shall fall within the protection scope of the present application. Therefore, the protection scope of the present application shall be subject to the protection scope of the claims.

What is claimed is:

1. A computer system, comprising:
n compute nodes;
n storage access apparatuses; and
m network storage devices, wherein at least one virtual machine (VM) runs on each of the n compute nodes, the m network storage devices provide distributed storage resources for the at least one virtual machine, and n and m are integers greater than or equal to 1,
wherein each of the n storage access apparatuses comprises a processing unit, a first interface, and a second interface, wherein the storage access apparatus is coupled to at least one of the n compute nodes via the first interface, and the storage access apparatus is coupled to at least one of the m network storage devices via the second interface,
the storage access apparatus supports single-root I/O virtualization (SR-IOV) and is configured to: configure at least one virtual function (VF) using a physical function (PF) of the SR-IOV, and configure a VM-VF association relationship, so that a direct access path is established between a VM and a VF that are associated, wherein one VM corresponds to one VF, and
the storage access apparatus supports a distributed storage resource scheduling function and is configured to: obtain, via the second interface, data block resources provided by the at least one network storage device that is coupled to the storage access apparatus, form a plurality of virtual volumes using the obtained data block resources, and configure a VF-virtual volume association relationship, wherein one VF corresponds to at least one virtual volume.

2. The computer system according to claim 1, wherein a PF back-end driver is deployed in the storage access apparatus, and a PF front-end driver is deployed in the compute node coupled to the storage access apparatus;
after being started, the storage access apparatus loads the PF back-end driver to perform initialization configuration; and
the compute node coupled to the storage access apparatus loads the PF front-end driver, obtains resource information of the storage access apparatus using the PF front-end driver, and delivers a configuration command to the storage access apparatus based on the resource information of the storage access apparatus, so that the storage access apparatus performs resource configuration to allocate corresponding hardware resources to the PF and each VF.

3. The computer system according to claim 2, wherein after receiving a first VM association command sent by an upper-layer application, the compute node coupled to the storage access apparatus forwards the first VM association command to the PF back-end driver using the PF front-end driver; and
wherein the storage access apparatus is configured to:
after receiving the first VM association command using the PF back-end driver module, configure a corresponding first VF for a first VM designated in the first VM association command, and
record an association relationship between the first VM and the first VF.

4. The computer system according to claim 1, wherein the storage access apparatus is configured to:
receive an allocation request for allocating a storage resource to the first VM,
determine the first VF associated with the first VM,
allocate at least one of the plurality of virtual volumes to the first VM,
create an association relationship between the allocated at least one virtual volume and the first VF, and
return an allocation response, wherein the allocation response comprises information about the at least one virtual volume that is allocated to the first VM.

5. The computer system according to claim 4, wherein the allocation request for allocating a storage resource to the first VM is a request for creating a virtual volume for the first VM or a request for attaching a virtual volume to the first VM.

6. The computer system according to claim 4, wherein the first VF of the storage access apparatus is further configured to:
receive an I/O request of the first VM using the direct access path,
place the I/O request into an I/O queue of the first VF,
determine, based on the virtual volume associated with the first VF, a data block that is in the network storage device and that corresponds to the I/O request, and
execute a read or write operation on the data block that is in the network storage device and that corresponds to the I/O request.

7. The computer system according to claim 1, wherein the first interface is a Peripheral Component Interconnect Express (PCIe) interface and the second interface is a network interface.

8. A storage access apparatus, comprising:
a processing unit;
a first interface; and
a second interface, wherein the storage access apparatus is coupled to a processor of a compute node by using the first interface, and the storage access apparatus is coupled to at least one network storage device via the second interface;
at least one virtual machine (VM) runs on the compute node, and the at least one network storage device provides distributed storage resources for the at least one virtual machine,
wherein the storage access apparatus comprises a direct access module to support single-root I/O virtualization (SR-IOV) and is configured to:
perform virtualization to obtain at least one virtual function (VF) using a physical function PF of the SR-IOV function, and
configure a VM-VF association relationship, so that a direct access path is established between a VM and a VF that are associated, wherein one VM corresponds to one VF, and
wherein the storage access apparatus further comprises a resource scheduler to support a distributed storage resource scheduling function and is configured to:
obtain, using the second interface, data block resources provided by the at least one network storage device that is coupled to the storage access apparatus,
form a plurality of virtual volumes using the obtained data block resources, and
configure a VF-virtual volume association relationship, wherein one VF corresponds to at least one virtual volume.

9. The storage access apparatus according to claim 8, wherein the resource scheduler is configured to:
receive an allocation request for allocating a storage resource to a first VM,
allocate at least one of the plurality of virtual volumes to the first VM,
create an association relationship between the allocated at least one virtual volume and a first VF based on the first VF associated with the first VM and determined by the direct access module, and
return an allocation response having information about the at least one virtual volume that is allocated to the first VM.

10. The storage access apparatus according to claim 9, wherein the allocation request for allocating a storage resource to the first VM is a request for creating a virtual volume for the first VM or a request for attaching a virtual volume to the first VM.

11. The storage access apparatus according to claim 8, wherein the first VF of the direct access module is further configured to:
receive an I/O request of the first VM using the direct access path, and
place the I/O request into an I/O queue of the first VF, wherein the resource scheduler determines, based on the virtual volume associated with the first VF, a data block that is in the network storage device and that corresponds to the I/O request, and executes a read or write operation on the data block that is in the network storage device and that corresponds to the I/O request.

12. The computer system according to claim 8, wherein the first interface is a Peripheral Component Interconnect Express (PCIe) interface and the second interface is a network interface.

13. A method of storage accessing, comprising:
receiving, by a storage access apparatus, an input/output (I/O) request from a first virtual machine (VM), wherein the storage access apparatus is one of n storage access apparatuses of a computer system, the computer system further including n computer nodes and m network storage devices, wherein at least one VM runs on each of the n computer nodes, wherein the m network storage devices provide distributed storage resources for the at least one VM, and wherein n and m are integers greater than or equal to 1;
determining, by the storage access apparatus, a first virtual function (VF) associated with the first VM;
placing, by the storage access apparatus, the I/O request into an I/O queue of the first VF;
determining, by the storage access apparatus based on a virtual volume associated with the first VF, at least one data block that is in a network storage device and that corresponds to the I/O request;
executing, by the storage access apparatus, a read or write operation on the at least one data block; and
sending, by the storage access apparatus, a result of the I/O request to the first VM.

14. The method of storage accessing according to claim 13, wherein a PF back-end driver is deployed in the storage access apparatus, and a PF front-end driver is deployed in the compute node coupled to the storage access apparatus;
loading, by the storage access apparatus after being started, the PF back-end driver to perform initialization configuration;
receiving, by the storage access apparatus, a configuration command from the compute node;
performing, by the storage access apparatus, resource configuration, to allocate corresponding hardware resources to a physical function (PF) and each VF.

15. The method of storage accessing according to claim 13, wherein before the storage access apparatus receives the I/O request from the first VM, the method further comprises:
receiving, by the storage access apparatus, an allocation request for allocating a storage resource to the first VM;
determining, by the storage access apparatus, the first VF associated with the first VM;
allocating at least one of a plurality of virtual volumes to the first VM;
creating, by the storage access apparatus, an association relationship between the allocated at least one virtual volume and the first VF; and
returning, by the storage access apparatus, an allocation response, wherein the allocation response comprises information about the at least one virtual volume that is allocated to the first VM.

16. The method of storage accessing according to claim 15, wherein the allocation request for allocating a storage resource to the first VM is a request for creating a virtual volume for the first VM or a request for attaching a virtual volume to the first VM.

17. The method of storage accessing according to claim 13, wherein the first interface is a Peripheral Component Interconnect Express (PCIe) interface and the second interface is a network interface.
